(19) United States
(12) Patent Application Publication
(10) Pub. No.: US 2013/0059586 A1
(43) Pub. Date: Mar. 7, 2013

(54) NETWORK SEARCHING METHODS AND APPARATUSES FOR MULTI-MODE USER EQUIPMENT

(71) Applicants: Zengyu HAO, Beijing City (CN); Junzhen QIN, Beijing City (CN); Xinwei CUI, Beijing (CN); Chao-Hsun CHENG, Taipei City (TW)

(72) Inventors: Zengyu HAO, Beijing City (CN); Junzhen QIN, Beijing City (CN); Xinwei CUI, Beijing (CN); Chao-Hsun CHENG, Taipei City (TW)

(73) Assignee: MEDIATEK SINGAPORE PTE. LTD., Singapore (SG)

(21) Appl. No.: 13/599,134

(22) Filed: Aug. 30, 2012

(30) Foreign Application Priority Data
Sep. 2, 2011 (CN) 201110258390.9
Jul. 12, 2012 (CN) 201210242227.8

(51) Int. Cl. H04W 36/00

(52) U.S. Cl. 455/436

(57) ABSTRACT

A network searching method for a multi-mode user equipment having a first radio access technology module and a second radio access technology module includes camping on a current cell by the user equipment via the first radio access technology module; obtaining information broadcast by a system of the second radio access technology module via the first radio access technology module when network environment corresponding to the first radio access technology module changes; and instructing the second radio access technology module to perform a network searching.

### CROSS REFERENCE TO RELATED APPLICATIONS

This Application claims priority of China Patent Application No. 201110258390.9, filed on Sep. 2, 2011, and China Patent Application No. 201210242227.8, filed on Jul. 12, 2012, the entirety of which is incorporated by reference herein.

### BACKGROUND OF THE INVENTION

1. Field of the Invention

The invention relates to a multi-mode dual-standby single-USIM card terminal, and more particularly to a network searching method and apparatus for a multi-mode user equipment.

2. Description of the Related Art

The Long Term Evolution (LTE) multi-mode dual-standby single Universal Subscriber Identity Module (USIM) card terminal is a novel mobile terminal When compared with the conventional multi-mode single-standby single-USIM card terminal, the former can access both LTE and 2G (or 3G) radio networks at the same time by using only one USIM card while the later can only access an LTE or 2G (or 3G) radio network at the same time by using one USIM card.

The LTE multi-mode dual-standby single-USIM card terminal (hereinafter called the terminal for brevity) has four main advantages, including: 1) high speech service quality because the speech traffic is carried on 2G or 3G carrier(s), 2) high flexibility because the packet switch (PS) traffic can be switched between 2G (or 3G) and LTE radio networks according to the current network condition, 3) less effort on configuration and network optimization for operators and 4) stronger roaming ability because the LTE and 2G (or 3G) network can register at different Public Land Mobile Networks (PLMN).

Because the multi-mode multi-connected User Equipment (UE) has multiple Radio access Technology (RAT) modules (RAT Modem), the multi-mode multi-connected UE can support the standby or connection state of multiple RAT Modems (such as GSM, WCDMA, TD-SCDMA, CDMA2000, LTE, WiMax, WiFi, or others). Therefore, information sharing between multiple RAT modules (such as Modem) has become important and meaningful.

The mechanism for searching a service network under a 3G CELL_DCH (or 2G DEDICATED) mode for a terminal is: when the terminal moves from an area without LTE coverage to an area with LTE coverage, the PS traffic could be carried on the LTE carrier(s); and when the terminal moves from an area with LTE coverage to an area without LTE coverage, the PS traffic could be carried on the 2G (or 3G) carrier(s).

### BRIEF SUMMARY OF THE INVENTION

An exemplary embodiment of the invention provides a network searching method for a multi-mode user equipment (UE) comprising a first radio access technology (RAT) module and a second RAT module. The network searching method comprises: camping on a current cell via the first RAT module of the UE; obtaining information broadcast about a system of the second RAT module via the first RAT module when network environment corresponding to the first RAT module changes; and determining whether to instruct the second RAT module to perform a network searching.

Another exemplary embodiment of the invention provides a network searching method for a multi-mode single-card user equipment (UE) comprising a first radio access technology (RAT) module and a second RAT module. The network searching method comprises: setting an expiry time of a timer to a first length when the first RAT module camps on a current cell and the second RAT module is in a no-service state; enabling the timer; performing a network searching by the second RAT module after the timer expires.

Another exemplary embodiment of the invention provides a multi-mode user equipment (UE). The multi-mode user equipment comprises a first radio access technology (RAT) module and a second RAT module coupled to the first RAT module. The UE camps on a current cell via the first RAT module and when network environment corresponding to the first RAT module changes, information broadcasted about a system of the second RAT module is obtained via the first RAT module and the second RAT module is determined whether to perform a network searching.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1A shows a flow chart of a first method when the terminal is switched to a 3G cell according to an embodiment of the invention;

FIG. 1B shows a flow chart of a first method when the terminal is switched to a 2G cell according to an embodiment of the invention;

FIG. 2A and FIG. 2B show a flow chart of a second method according to an embodiment of the invention; and

FIG. 3A and FIG. 3B show a flow chart of a third method according to an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

Some specific terms are used in the specification and claims to refer to specific elements. Those skilled in the art would readily appreciate that the electronic device manufactures can use different terms to name the same element. In the specification and claims, instead of their names, the corresponding functions are utilized to distinguish between different elements. The term “comprise” as referred in the specification and claims is an open term and should be interpreted as “comprise but not limited to”. In addition, the term “couple” refers to any direct or indirect electronic connection. Therefore, when saying a first device is coupled to a second device, the first device can be directly and electronically connected to the second device, or can be indirectly and electronically connected to the second device via other device(s) or connecting method(s).

When a terminal is operated under a 3G cell Dedicated Channel (CELL_DCH) or a 2G dedicated channel (2G DEDICATED) mode and then is moved from an area without LTE coverage to an area with LTE coverage, the terminal is not aware of the appearance of the LTE coverage for the following two main reasons: 1) based on the current standard, the terminal does not listen to the broadcast System information block 19 (SIB 19) or the System Information Type 2 Quarter (SI2 Quarter), in which information regarding LTE neighbor cell(s) is carried, when the terminal is operated under the 3G CELL_DCH or 2G DEDICATED mode, and 2) for the terminal developed according to a standard with a version lower than release 7 (REL7) (including the REL7), it is specified in the standards that the network will not notify the terminal of the appearance of the LTE neighbor cell in the Measurement Control or Measurement Information message when the terminal operates under the 3G CELL_DCH or 2G DEDICATED mode, because the terminal will inform the network that the LTE related procedure is not supported when the terminal reports the network support capability to the network.

In view of the above problems, some solutions are provided in the specification. A location of the terminal operating under a connected mode, such as the 3G CELL_DCH or 2G DEDICATED mode, may change due to the movement of the UE, and the network environment may also changes with time. The above-mentioned two conditions reveals that a major change of the network environment of the terminal may occur, which means that the terminal may move from an area without LTE coverage to an area with LTE coverage. When the terminal has detected the above changes, the LTE module (for example, the LTE Modem) may be triggered or instructed to search for a service network as soon as possible so as to hand off the PS traffic to the LTE network. If the terminal has not detected the above changes, the LTE module may operates in a power saving mode. In this manner, both the power saving and fast LTE service recovery can be achieved. Based on the concept, three methods are provided. In method 1, no matter whether the terminal is switched to a 3G cell or a 2G cell, the LTE neighbor cell information carried in the obtained cell system information are provided to the LTE Modem for determining network environment change. In method 2, the terminal determines network environment change by determining a handover or neighbor cell change under 3G CELL_DCH or 2G DEDICATED mode. In method 3, the terminal uses the supplemental device, such as a Global Positioning System (GPS) module or an Assisted Global Positioning System (AGPS) module, to determine network environment change under a 3G CELL_DCH mode or a 2G DEDICATED mode.

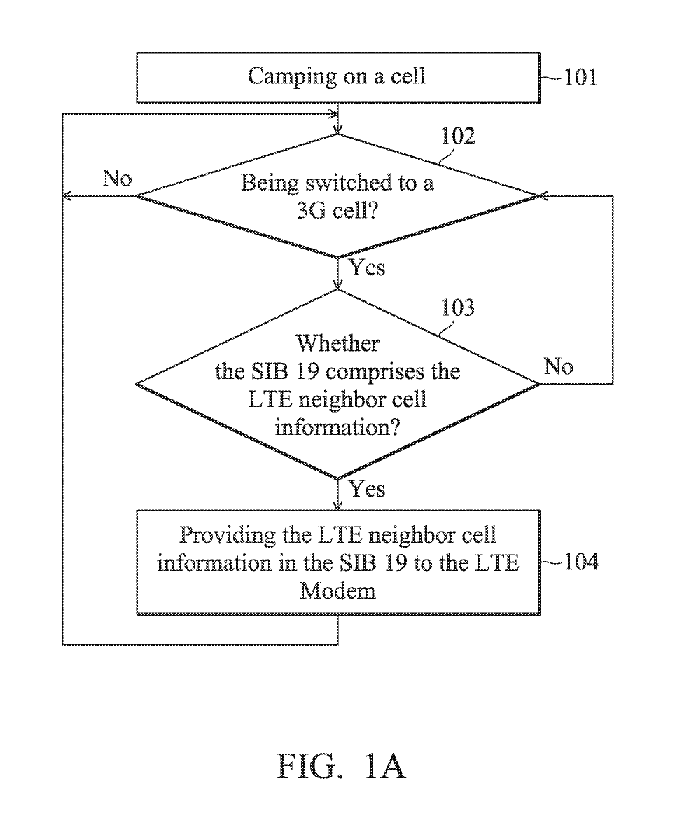

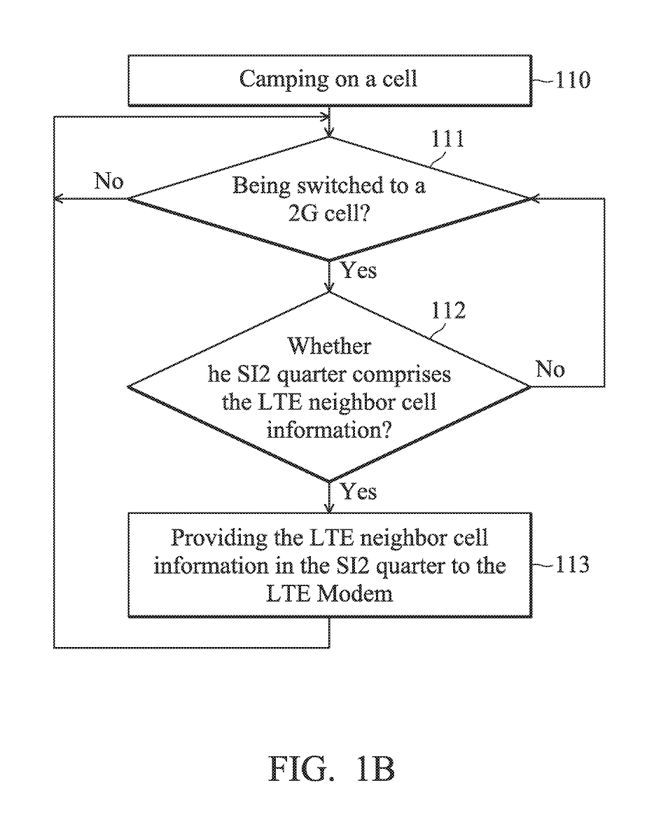

FIG. 1A shows a flow chart of a first method when the terminal is switched to a 3G cell according to an embodiment of the invention. When the UE camps on a cell (Step 101) and cell handover occurs, for example, the UE is switched to a 3G cell (such as a TD-SCDMA cell) (Step 102), the UE receives the SIB 19 from the current cell (which the UE camps on) or a neighbor cell and determines whether the SIB 19 comprises the LTE neighbor cell information (Step 103). When the received SIB 19 comprises the LTE neighbor cell information, the LTE neighbor cell information in the SIB 19 is provided to the LTE module (such as the LTE Modem) (Step 104) to trigger and speed up the LTE network searching. Those skilled in the art would readily appreciate that network searching may also be referred to as finding a service network.

FIG. 1B shows a flow chart of method 1 when the terminal is switched to a 2G cell according to an embodiment of the invention. When the UE camps on a cell (Step 110) and cell handover occurs, for example, the UE is switched from a 3G cell to a 2G cell (Step 111), the UE may receive the SI2 Quarter from the current cell which the UE camps on or a neighbor cell and determine whether the SI2 Quarter comprises the LTE neighbor cell information (Step 112). When the received SI2 Quarter comprises the LTE neighbor cell information, the LTE neighbor cell information in the SI2 Quarter is provided to the LTE module, such as the LTE Modem (Step 113), to trigger and speed up the LTE network searching.

According to an embodiment of the invention, a network searching apparatus performing the methods as shown in FIG. 1A and FIG. 1B may be implemented by an UE camping on a current cell, such as a 3G cell or a 2G cell, via a first RAT module. The UE may further detect network environment change via the first RAT module. The network environment change may be, for example, handover. When the network environment change has been detected, the first RAT module may obtain broadcast system information, such as the SIB 19 or SI2 Quarter, from the current cell or a neighbor cell, and provide the obtained LTE neighbor cell information to the second RAT module (LTE module) so as to instruct the second RAT module (LTE module) to perform a network searching.

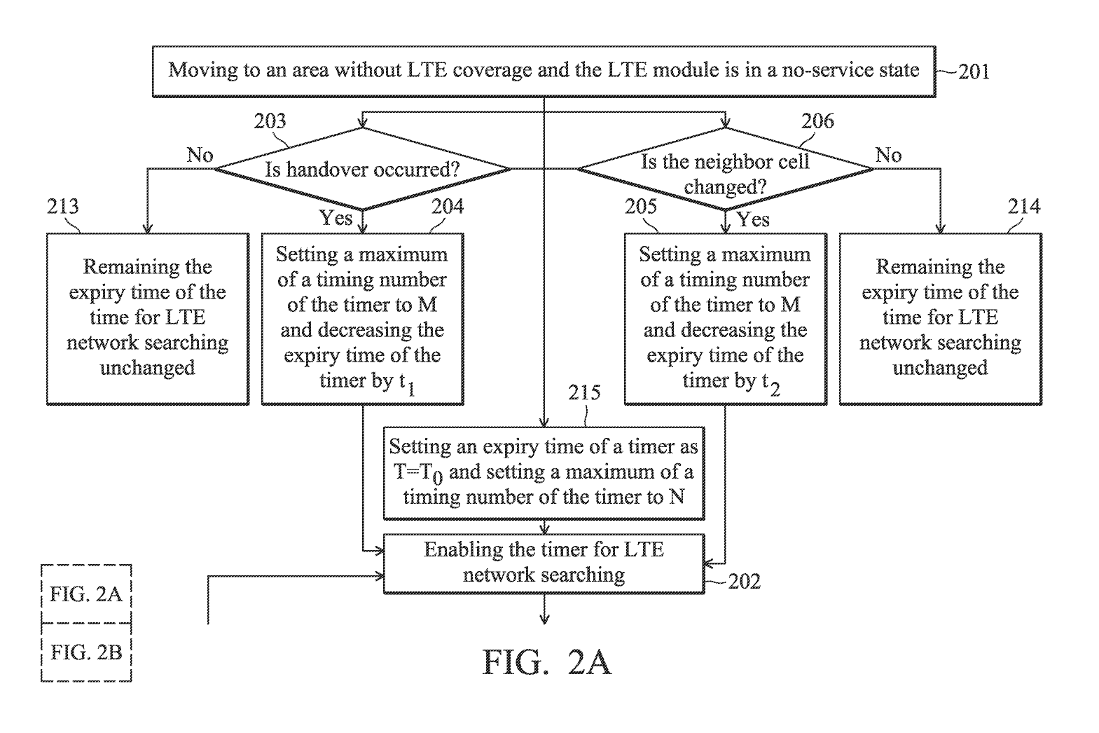

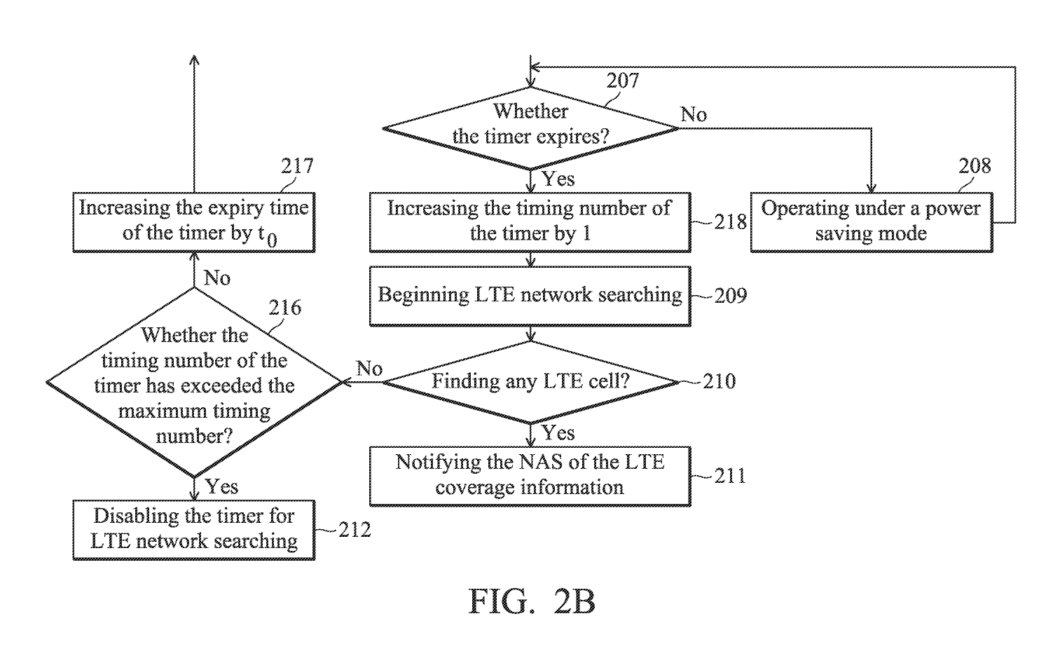

FIG. 2A and FIG. 2B show a flow chart of a second method according to an embodiment of the invention. Referring to FIG. 2A and FIG. 2B, in step 201, when the terminal operating under a 3G CELL_DCH (or 2G DEDICATED) mode moves to an area without LTE coverage, the LTE module is in a no-service state. At this time, an expiry time of a timer may be set as T=T₀, a maximum of a timing number of the timer may be set to N and an initial value of the timing number of the timer may be set to 0 in step 215. In step 202, the timer for LTE network searching is enabled. Before the timer expires (the NO path for step 207), the terminal operates under a power saving mode (step 208) and the timer keeps counting. When the timer expires (the YES path for step 207), the timing number of the timer is increased by 1 and the LTE network searching may begin (step 209). If there is no LTE cell found in step 210 (the NO path for step 210), it is further determined that whether the timing number of the timer has exceeded the maximum timing number (step 216). When the timing number of the timer has not exceeded the maximum timing number (the NO path for step 216), the expiry time of the timer is increased in step 217 (for example, T=T₀+t₀, t₀>0) and the timer for LTE network searching is enabled again in step 202. On the other hand, when the timing number of the timer has exceeded the maximum timing number (the Yes path for step 216), the timer for LTE network searching is disabled (step 212). In the above process, when there is any LTE cell found in step 210, the Non-Access Stratum (NAS) of the terminal may be notified of the LTE coverage information (step 211) and the NAS may further determine whether to register at the LTE network. If the handover occurs when the terminal operates under the 3G CELL_DCH (or 2G DEDICATED) mode (the Yes path for step 203), the maximum of a timing number of the timer is set to M and the expiry time of the timer for LTE network searching is decreased (for example, T=T−t₁,t₁>0) and the timer for LTE network searching is enabled again in step 202. If the handover does not occur (the No path for step 203), the expiry time of the timer for LTE network searching remains unchanged (step 213). If the terminal detects that neighbor cell changes under the 3G CELL_DCH (or 2G DEDICATED) mode (the Yes path for step 206), the maximum of the timing number of the timer is set to M and the expiry time of the timer for LTE network searching is decreased (for example, T=T−t₂,t₂>0) and the timer for LTE network searching is enabled again in step 202. If the terminal does not detect that neighbor cell changes under the 3G CELL_DCH (or 2G DEDICATED) mode (the No path for step 206), the expiry time of the timer for LTE network searching remains unchanged (step 214).

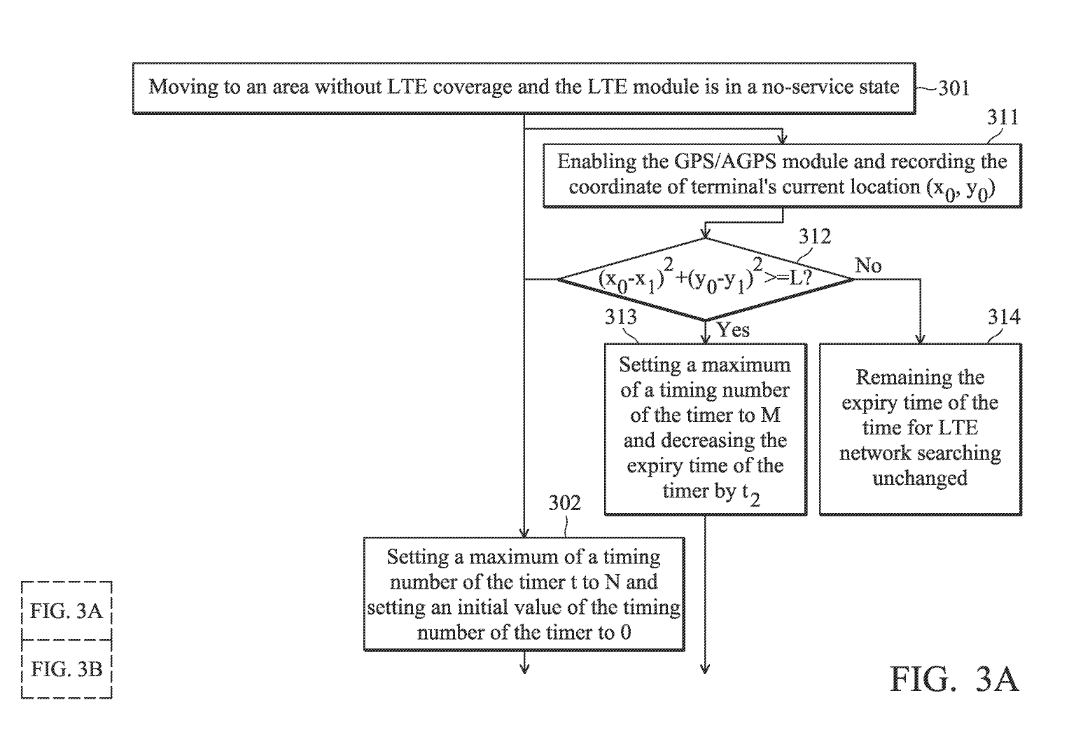

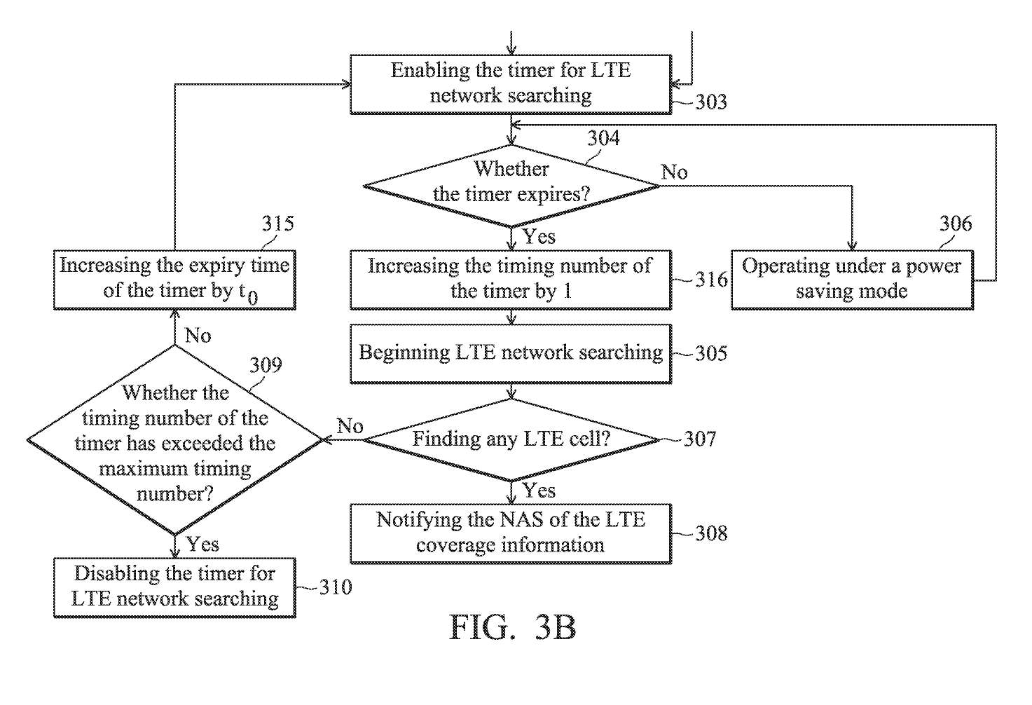

FIG. 3A and FIG. 3B show a flow chart of a third method according to an embodiment of the invention. Referring to FIG. 3A and FIG. 3B, in step 301, when the terminal operating under a 3G CELL_DCH (or 2G DEDICATED) mode moves to an area without LTE coverage, the LTE module is in a no-service state. At this time, in step 302, an expiry time of a timer may be set as T=T₀, a maximum of a timing number of the timer may be set to N and an initial value of the timing number of the timer may be set to 0. In addition, the GPS/AGPS module is enabled for recording the coordinate of terminal's current location (x₀, y₀) in step 311. After setting the maximum timing number and the expiry time, the timer for LTE network searching is enabled in step 303. Before the timer expires (the NO path for step 304), the terminal operates under a power saving mode (step 306) and the timer keeps counting. When the timer expires (the YES path for step 304), the timing number of the timer is increased by 1 (step 316) and the LTE network searching may begin (step 305). If there is no LTE cell found in step 307 (the NO path for step 307), it is further determined that whether the timing number of the timer has exceeded the maximum timing number (step 309). When the timing number of the timer has not exceeded the maximum timing number (the NO path for step 309), the expiry time of the timer is increased in step 315 (for example, T=T₀+t₀, t₀>0) and the timer for LTE network searching is enabled again in step 303. On the other hand, when the timing number of the timer has exceeded the maximum timing number (the Yes path for step 309), the timer for LTE network searching is disabled (step 310). When there is any LTE cell found in step 307, the Non-Access Stratum (NAS) of the terminal may be notified of the LTE coverage information (step 308) and the NAS may further determine whether to register at the LTE network. In the above process, after enabling the GPS/AGPS module and recording the coordinate of terminal's current location (x₀, y₀), when the terminal moves to another location (x₁,y₁) and it is satisfied that (x₀−x₁)²+(y₀−y₁)²>=L (the Yes path for step 312), the maximum of the timing number of the timer is set to M and the expiry time of the timer for LTE network searching is decreased (for example, T=T−t₂,t₂>0) (step 313) and the timer for LTE network searching is enabled again (step 303). When the terminal moves to the location (x₁,y₁) and (x₀−x₁)²+(y₀−y₁)²<L (the No path for step 312), the expiry time of the time for LTE network searching remains unchanged (step 314).

While the invention has been described by way of example and in terms of preferred embodiment, it is to be understood that the invention is not limited to LTE terminals. The invention can further be implemented in other 3G terminals, such as WCDMA, TD-SCDMA, CDMA2000, LTE, WiMAX, WiFi and so on. Those who are skilled in this technology can still make various alterations and modifications without departing from the scope and spirit of this invention. Therefore, the scope of the present invention shall be defined and protected by the following claims and their equivalents.

What is claimed is:

1. A network searching method performed by a multi-mode user equipment (UE) comprising a first radio access technology (RAT) module and a second RAT module, comprising:
camping on a current cell via the first RAT module of the UE;
obtaining information broadcasted about a system of the second RAT module via the first RAT module when network environment corresponding to the first RAT module changes; and
determining whether to instruct the second RAT module to perform a network searching according to the information broadcasted.

2. The method as claimed in claim 1, wherein a change in the network environment corresponding to the first RAT module comprises the first RAT module performing a cell handover, a neighbor cell of the first RAT module changed, or a geographic location of the UE changed.

3. The method as claimed in claim 2, wherein one condition for determining whether the geographic location of the UE changes comprises:
determining that the geographic location of the UE changes when a major change in the geographic location of the UE is detected by a global positioning system (GPS) module of the UE.

4. The method as claimed in claim 2, wherein the information broadcast is broadcast system information monitored by the first RAT module.

5. The method as claimed in claim 2, wherein the first RAT module is determined to have performed the cell handover when the service on the second RAT module is switched to the 2G cell or 3G cell via the first RAT module because of lost coverage

6. The method as claimed in claim 5, wherein when the service on the second RAT module is switched to the 3G cell via the first RAT module because of lost coverage, the broadcast system information is the SIB19 broadcasted by the current cell or a neighbor cell.

7. The method as claimed in claim 5, wherein when the service on the second RAT module is switched to the 2G cell via the first RAT module because of lost coverage, the broadcast system information is the SI2 broadcasted by the current cell or a neighbor cell.

8. The method as claimed in claim 1, wherein the first RAT module is a 2G Modem or a 3G Modem, and the second RAT module is a LTE Modem.

9. The method as claimed in claim 1, wherein the UE operates under a 2G or 3G dedicated channel mode.

10. A network searching method performed by a multi-mode single-card user equipment (UE) comprising a first radio access technology (RAT) module and a second RAT module, comprising:
setting an expiry time of a timer to a first length when the first RAT module camps on a current cell and the second RAT module is in a no-service state;
enabling the timer;
performing a network searching by the second RAT module after the timer expires.

11. The method as claimed in claim 10, wherein a maximum of a timing number of the timer is set to a first value and an initial value of the timing number of the timer is set to 0 when the first RAT module camps on the current cell and the second RAT module is in the no-service state, and when the timer expires, the method further comprises:
increasing the timing number of the timer by 1 and performing the network searching by the second RAT module;
determining whether the timing number of the timer has exceeded the first value when the second RAT module does not find out any network; and
setting the expiry time of the timer to a second length longer than the first length when the timing number of the timer has not exceeded the first value.

12. The method as claimed in claim 10, further comprising:
setting the expiry time of the timer to a third length, setting a maximum of a timing number of the timer to a second value and setting an initial value of the timing number of the timer to 0 when the second RAT module is in the no-service state and the first RAT module has performed a cell handover;
enabling the timer;
increasing the timing number of the timer by 1 and performing the network searching by the second RAT module when the timer expires;
determining whether the timing number of the timer has exceeded the second value when the second RAT module does not find out any network; and
setting the expiry time of the timer to a fourth length longer than the third length when the timing number of the timer has not exceeded the second value.

13. The method as claimed in claim 10, further comprising:
setting the expiry time of the timer to a fifth length, setting a maximum of a timing number of the timer to a third value and setting an initial value of the timing number of the timer to 0 when the second RAT module is in the no-service state and the first RAT module is detected that a neighbor cell changes;
enabling the timer;
increasing the timing number of the timer by 1 and performing the network searching by the second RAT module when the timer expires;
determining whether the timing number of the timer has exceeded the third value when the second RAT module does not find out any network; and
setting the expiry time of the timer to a sixth length longer than the fifth length when the timing number of the timer has not exceeded the third value.

14. The method as claimed in claim 10, further comprising:
enabling a global positioning system (GPS) module of the UE to record a first coordinate of a current location of the UE;
setting the expiry time of the timer to a seventh length, setting a maximum of a timing number of the timer to a fourth value and setting an initial value of the timing number of the timer to 0 when a distance between the first coordinate and a location where the UE moves to has exceeded a predefined value;
enabling the timer;
increasing the timing number of the timer by 1 and performing the network searching by the second RAT module when the timer expires;
determining whether the timing number of the timer has exceeded the fourth value when the second RAT module does not find out any network; and
setting the expiry time of the timer to an eighth length longer than the seventh length when the timing number of the timer has not exceeded the fourth value.

15. The method as claimed in claim 10, further comprising:
when the second RAT module has found out a network, notifying a non-access stratum of obtained network coverage information and determining whether to register at the network by the non-access stratum.

16. A multi-mode user equipment (UE), comprising
a first radio access technology (RAT) module, wherein the UE camps on a current cell via the first RAT module; and
a second RAT module, coupled to the first RAT module,
wherein when network environment corresponding to the first RAT module changes, information broadcasted about a system of the second RAT module is obtained via the first RAT module and the second RAT module is determined whether to perform a network searching according to the information broadcasted.

17. The multi-mode UE as claimed in claim 16, wherein the change in the network environment corresponding to the first RAT module comprises the first RAT module performing a cell handover, a neighbor cell of the first RAT module changes, or a geographic location of the UE changes.

18. The multi-mode UE as claimed in claim 17, wherein one condition for determining whether the geographic location of the UE changes comprises determining that the geographic location of the UE changes, when a major change in the geographic location of the UE is detected by a global positioning system (GPS) module of the UE.

19. The multi-mode UE as claimed in claim 17, wherein the broadcast information is the broadcast system information monitored by the first RAT module.

20. The multi-mode UE as claimed in claim 17, wherein the first RAT module is determined to have performed the cell handover when the service on the second RAT module is switched to the 2G cell or 3G cell via the first RAT module because of lost coverage.

21. The multi-mode UE as claimed in claim 20, wherein when the service on the second RAT module is switched to the 3G cell via the first RAT module because of lost coverage, the broadcast system information is the SIB 19 broadcast by the current cell or a neighbor cell.

22. The multi-mode UE as claimed in claim 20, wherein when the service on the second RAT module is switched to the 2G cell via the first RAT module because of lost coverage, the broadcast system information is the SI2 broadcast by the current cell or a neighbor cell.

23. The multi-mode UE as claimed in claim 16, wherein the first RAT module is a 2G or a 3G Modem, and the second RAT module is a LTE Modem.

24. The multi-mode UE as claimed in claim 16, wherein the UE operates under a 2G or 3G dedicated channel mode.
